(19) United States
(12) Patent Application Publication
(10) Pub. No.: US 2006/0263132 A1
(43) Pub. Date: Nov. 23, 2006

(54) Tape printing control device and program

(75) Inventors: Yoshijiro Yamamoto, Aichi-ken (JP); Akihiro Sawada, Aichi-ken (JP); Toshihide Fujikawa, Aichi-ken (JP); Mizue Terai, Aichi-ken (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Aichi (JP)

(21) Appl. No.: 10/529,791

(22) PCT Filed: Oct. 30, 2003
(86) PCT No.: PCT/JP03/13968

§ 371 Date: Apr. 19, 2005

(30) Foreign Application Priority Data
Oct. 31, 2002 (JP) 2002-319066

(51) Int. Cl. B41J 5/30

(52) U.S. Cl. 400/62

(57) ABSTRACT

The number of lines of character strings to be printed on a cable label 11 is calculated (S730) and line spacing is calculated so that the distance between the lines of the character strings of the calculated number of lines will be equalized (S740). A print image rotated counterclockwise by 90 degrees is generated so that the character string will be in the width direction of the print tape 10 (S750). Printing is executed (S790) by successively arranging print images for the calculated number of lines while placing print images at both ends of the cable label 11 (S760) and securing the calculated line spacing.

### TECHNICAL FIELD

The present invention relates to a tape printing control device and a program which are used for printing a character string on a tape-like print medium.

### BACKGROUND OF THE INVENTION

Tape printers, capable of printing a character string on a print tape made of an adhesive print sheet (with an adhesive agent previously applied on its back) and a releasable sheet which are bonded together to be releasable, are well known. With a tape printer of this type, a title, caption, etc. can be printed on the surface of a print sheet of print tape easily and beautifully. By peeling the releasable sheet away from the print tape on which a desired character string, etc. have been printed, the print sheet can be used as a label which can be stuck on the spine of a file, videotape, etc. Due to such high usability, tape printers are widely used for office use, home use, etc.

Meanwhile, with the progress of computers and network technologies of recent years, users in offices and homes are frequently experiencing situations where numbers of plugs at ends of cables have to be plugged into numbers of sockets of a device. As a way to prevent faulty wiring in such cases, it is effective to put a label (with a character string printed thereon for identification) on each cable to be plugged into a socket. Japanese Patent Provisional Publication No. HEI06-247431 (pages 5-7, FIG. 7) (hereinafter referred to as a “document #1”) has proposed a tape printer which can set a necessary “wound part” in a label to be wound around a cable and print identical character strings (arranged in the lengthwise direction of the print tape) on parts of the label outside the wound part. By winding the label (after being printed on by the tape printer) around the cable while sticking its both ends together, the user can more surely recognize a socket into which the cable should be plugged.

However, when such a label printed on by the tape printer of the document #1 is stuck on a cable, the part(s) printed with the character strings protrudes from the cable and that hampers the handling of the cable.

A tape printer that can avoid the above problem has been described in Japanese Patent Provisional Publication No. HEI06-320826 (pages 5-10, FIG. 14) (hereinafter referred to as a “document #2”). The tape printer of the document #2 is capable of printing a character string which has been rotated from the lengthwise direction of the print tape by 90 degrees, that is, the tape printer can print a character string in the width direction of the print tape. By cutting the print tape (printed on by the tape printer) in a length suitable for winding it around the cable, a cable identification label leaving no part protruding from the cable can be created.

### DISCLOSURE OF THE INVENTION

However, the tape printer described in the document #2 involves the following problems. In the tape printer of the document #2, the character string is printed generally on a front end part of the print tape in regard to the lengthwise direction of print tape and the label is formed by cutting the printed tape in a proper length required by the user. Therefore, when such a label is wound around a cable having a perimeter shorter than the length of the label starting from the front end of the label printed with the character string, a margin at the rear end of the label can cover and conceal part of the character string at the front end of the label, hampering the recognition of the character string. In such cases, the user is required to do complicated work such as switching the starting end of label winding, recut the label in a length avoiding the concealment of the character string, etc.

With conventional tape printers, it is possible to set the printing position or margin length so that the character string will not be concealed when the label is wound around the cable. However, such adjustment is very troublesome to users. Further, on the label created with the tape printer of the document #2, the character string is printed at only one position and there are cases where the user seeing the cable from the side opposite to the character string can not easily recognize the character string depending on the thickness of the cable, which is very inconvenient to the user.

It is of course possible to create a label printed with a plurality of character strings rotated 90 degrees from the lengthwise direction of the print tape by use of the tape printer of the document #2, by pressing the print key for a number of times, specifying printing of a plurality of labels, etc. When such a label is wound around a cable, at least one of the character strings printed on the label can be recognized. However, such work requires much time and effort of the user. Further, depending on the lengths of margins and the degree of tape feed operation, the character strings can be arranged lopsidedly in the front part or rear part of the created label when the print tape after being printed with a plurality of character strings is cut in a necessary length. In such cases, labels having a very large margin (printed with no character string) are created. Such labels are undesirable for practical use.

It is therefore the primary object of the present invention to provide a tape printing control device and a program realizing the creation of a label ensuring visual recognition of a character string printed on the label when the label is wound around a cable-like member, irrespective of from which end the label is wound around the cable-like member.

Another object of the present invention is to provide a tape printing control device and a program capable of creating a label that can be recognized easily from any direction when the label is wound around a cable-like member while avoiding the lopsided printing of the character strings on the front part or rear part of the label.

Another object of the present invention is to provide a tape printing control device and a program with which a label having a length and width optimum for the winding around a cable-like member and achieving the above objects can be created with ease.

In accordance with an aspect of the present invention, there is provided a tape printing control device comprising character string storage means for storing a character string to be printed on a tape-like print medium, print range storage means for storing a range on the tape-like print medium in which the character string will be printed, character image generation means for generating a character image in which the character string stored in the character string storage means is arranged in a width direction of the tape-like print medium, and print control means for controlling print position of each character image so that the character image generated by the character image generation means will be printed at both ends of the range stored in the print range storage means in regard to a lengthwise direction of the tape-like print medium.

In accordance with another aspect of the present invention, there is provided a program that causes a computer to execute a character string storage step for storing a character string to be printed on a tape-like print medium, a print range storage step for storing a range on the tape-like print medium in which the character string will be printed, a character image generation step for generating a character image in which the character string stored by the character string storage step is arranged in a width direction of the tape-like print medium, and a print control step for controlling print position of each character image so that the character image generated by the character image generation step will be printed at both ends of the range stored by the print range storage step in regard to a lengthwise direction of the tape-like print medium.

By the tape printing control device and the program configured as above, a label, on which identical character strings (extending in the width direction of the print tape) are printed at both ends of the label in regard to the lengthwise direction of the print tape, can be created. With this label, the user can recognize the character string identifying the cable even when a front end part of the label wound around the cable is covered with a rear end part of the label. Therefore, an ideal cable identification label, allowing the user to wind the label around a cable, etc. without concern for the starting end of label winding, can be created.

Incidentally, such a program can be distributed to computers by storing the program in a removable record medium such as a CD-ROM, FD, MO, etc. or a fixed record medium such as a hard disk, or via a communication network such as the Internet by use of a wired/wireless telecommunication means.

### BRIEF DESCRIPTION OF THE DRAWINGS

FIG. 1 is an external view of a tape printer in accordance with an embodiment of the present invention.

FIGS. 2(a) through 2(e) show examples of labels printed by the tape printer of FIG. 1.

FIG. 3 is a block diagram showing the composition of a control system inside the tape printer of FIG. 1.

FIG. 4 is a flowchart showing an overall process executed by the tape printer of FIG. 1.

FIG. 5 is a flowchart showing the procedure of a print range setting executed by the tape printer of FIG. 1.

FIG. 6 is a flowchart showing the procedure of a print process executed by the tape printer of FIG. 1.

FIG. 7 is a flowchart showing the procedure of normal printing executed by the tape printer of FIG. 1.

FIG. 8 is a flowchart showing the procedure of rotated printing executed by the tape printer of FIG. 1.

FIG. 9 is a flowchart showing the procedure of cable label printing executed by the tape printer of FIG. 1.

### BEST MODE FOR CARRYING OUT THE INVENTION

Referring now to the drawings, a description will be given in detail of a preferred embodiment in accordance with the present invention.

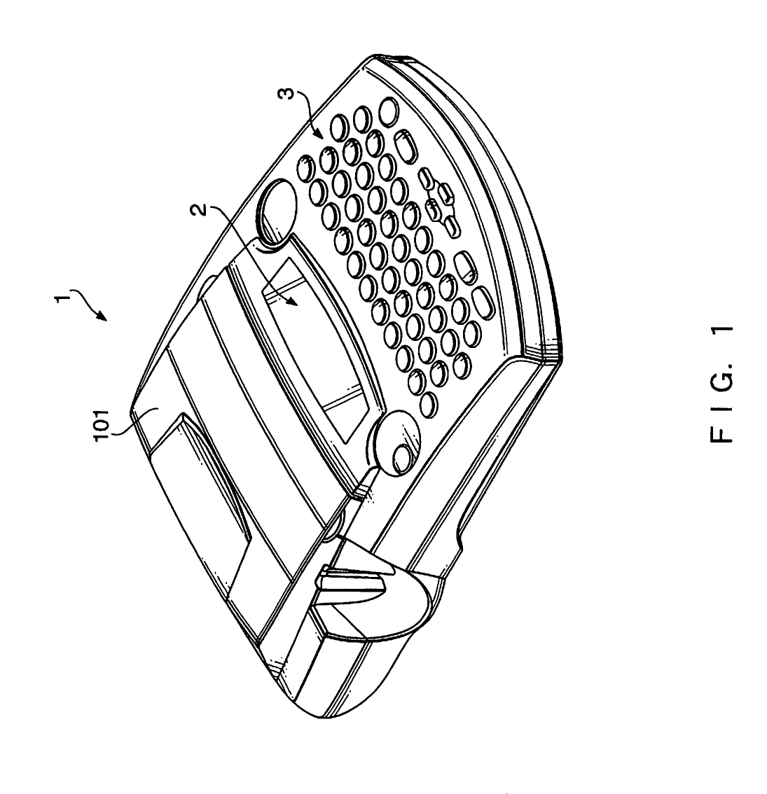

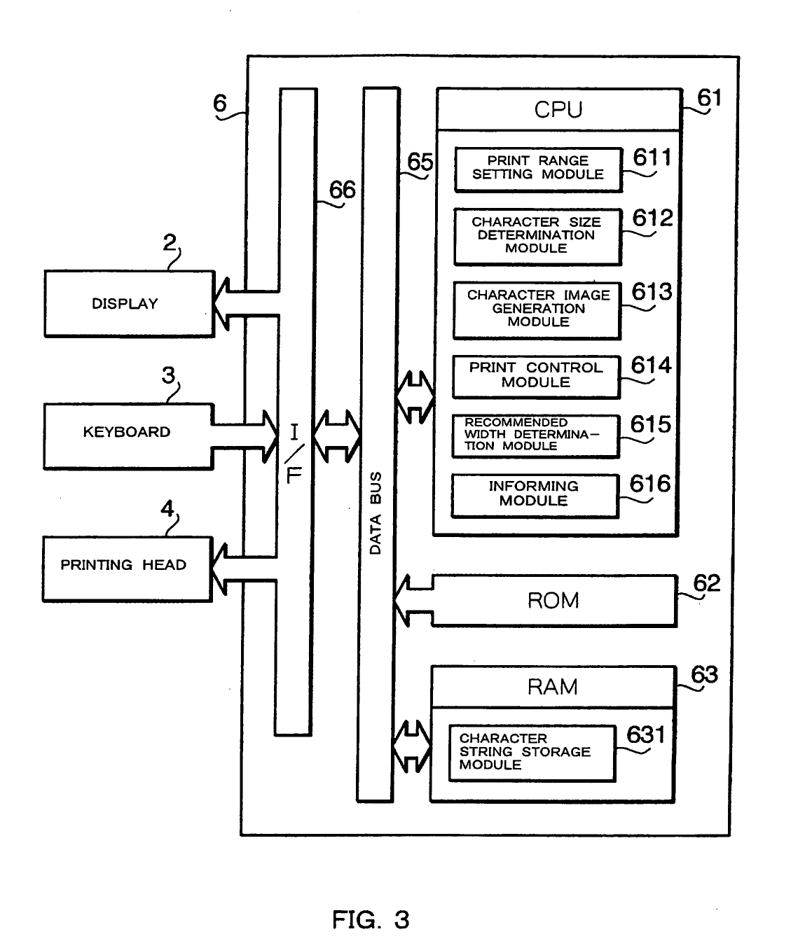

FIG. 1 is an external view of a tape printer 1 in accordance with an embodiment of the present invention. As shown in FIG. 1, the tape printer 1 has a display 2 and a keyboard 3 which are arranged in a front part of its top surface. In the rear part of the tape printer 1, a cover 101 is formed to be openable and closable. Inside the cover 101 of the tape printer 1, an unshown cassette storage part having a printing head 4 (see FIG. 3) is placed.

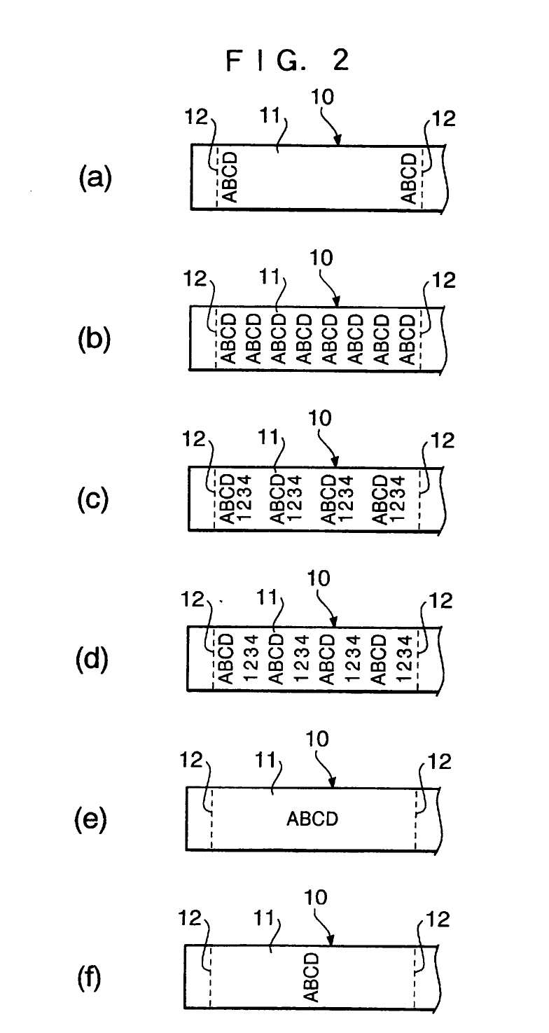

Print tape 10 (see FIG. 2(a)), as a record medium for the tape printer 1, includes a print sheet as a long tape-like print medium (having a print surface (on which characters, symbols, etc. are printed) on its front and an adhesive material layer on its back) and a releasable sheet (having a releasable surface processed with silicone resin, etc.) which are stacked up to be releasable. The print tape 10 is rolled up and stored in a tape cassette.

The tape cassette is loaded in the tape printer 1 detachably. On a lateral face of the tape cassette, a tape exposing part is formed in order to expose the print tape 10 for printing. The print tape 10 inside the tape printer 1 is pulled out from the tape cassette, printed on at the tape exposing part, and ejected to outside. By releasing the print sheet away from the releasable sheet (of the print tape which has been printed on as above), the user can use the released sheet as a label which can be stuck on an arbitrary object, article, etc.

Next, examples of labels obtained by the printing by the tape printer 1 will be described referring to FIGS. 2(a) through 2(e).

The tape printer 1 is capable of printing on the print tape 10 in various styles. The print styles include “normal printing”, “rotated printing” and “cable label printing”. In the “normal printing”, the character string is arranged in the lengthwise direction of the print tape 10. In the “rotated printing”, the character string is arranged in the width direction (orthogonal to the lengthwise direction) of the print tape 10. In the “cable label printing”, a cable label suitable for being stuck on a cable (hereinafter referred to as a “cable label 11”) is created by repetitively printing a character string (arranged in the width direction of the print tape 10) at both ends of a print range which has been set, or at both ends of the set print range and at even intervals in the range between the ends.

FIGS. 2(a) through 2(f) show examples of labels printed by the tape printer 1. Specifically, FIGS. 2(a)-2(d) show examples of cable labels 11 printed by the cable label printing, FIG. 2(e) shows an example of a label printed by the normal printing, and FIG. 2(f) shows an example of a label printed by the rotated printing. In this embodiment, cut marks 12 (broken lines) are printed at both ends of the set print range in the lengthwise direction of the print tape 10, as marks indicating cutting positions.

As shown in FIGS. 2(a)-2(d), on the cable label 11, a character string rotated counterclockwise from the lengthwise direction of the print tape 10 by 90 degrees (to be arranged in the width direction of the print tape 10) is repetitively arrange in the lengthwise direction of the print tape.

On the cable label 11 shown in FIG. 2(a), a character string “ABCD” rotated counterclockwise from the lengthwise direction of the print tape 10 is printed at both ends of the set print range. On the cable label 11 shown in FIG. 2(b), the character string “ABCD” rotated counterclockwise from the lengthwise direction of the print tape 10 is printed at both ends of the set print range and at even intervals between the ends. On the cable label 11 shown in FIG. 2(c), a print image composed of two lines of character strings “ABCD” and “1234” is printed at both ends of the set print range and at even intervals between the ends similarly to the example of FIG. 2(b). It is also possible to print a character string composed of a plurality of lines (such as “ABCD” and “1234”) at both ends of the set print range only, similarly to the example of FIG. 2(a).

On the cable label 11 shown in FIG. 2(d), separate lines of the character string composed of two lines “ABCD” and “1234” are printed at both ends of the set print range and between the ends evenly. In other words, the character strings “ABCD” and “1234” are printed alternately at even intervals.

FIG. 2(e) shows a label obtained by the normal printing. In this case, the character strings “ABCD” as the object of printing is printed in the lengthwise direction of the print tape 10.

FIG. 2(f) shows a label obtained by the rotated printing. In this case, the character strings “ABCD” as the object of printing is printed in the width direction of the print tape 10.

When the label of FIG. 2(e) obtained by the normal printing is wound around the cable so that the width direction of the label will be in parallel with the axial direction of the cable, the printed character string “ABCD” is arranged along a perimeter of the cable and thus it is difficult for the user to recognize the whole character string.

When the label of FIG. 2(f) obtained by the rotated printing is wound around the cable so that the width direction of the label will be in parallel with the axial direction of the cable, the printed character string “ABCD” can be concealed by a margin at the rear end of the label wound around the cable, depending on the thickness of the cable. In such cases, the user has to cut the rear end margin of the label in a proper length so as to avoid the concealment of the character string, or to set the character string printing position at an end of the print range and treat the end (printed with the character string) as the rear end of the label to be wound around the cable. Such work is very troublesome to the user.

Meanwhile, when each label shown in FIGS. 2(a)-2(d) is wound around the cable so that the width direction of the label will be in parallel with the axial direction of the cable, each character string printed on the cable label 11 is arranged in the axial direction of the cable and thus the user can easily recognize the character string. Further, since both ends of the label are printed with the character string, the user can necessarily recognize the character string regardless of which end of the label is wound around the cable first. Moreover, on the cable labels 11 shown in FIGS. 2(b)-2(d), a plurality of character strings are printed throughout the whole print range at even intervals, by which the user can recognize the character string irrespective of the visual angle around the cable, without the need of rotating the cable.

Next, the composition of the tape printer 1 will be described referring to FIG. 3. FIG. 3 is a block diagram showing the composition of a control system inside the tape printer 1. The tape printer 1 includes the display 2, the keyboard (first perimeter input means, second perimeter input means) 3, the printing head 4 and a control unit 6. The display 2 is implemented by a well-known liquid crystal display.

The keyboard 3 on the top surface of the tape printer 1 includes text keys for inputting characters to be printed, cursor keys for moving a cursor, function keys (print range setting key, print key, etc.) for calling various functions of the tape printer 1, etc.

The printing head 4 is installed in the cassette storage part, at a position corresponding to the tape exposing part formed on a lateral face of each tape cassette. On the printing head 4, a number of heating elements electrically controlled by the control unit 6 are arranged in the width direction of the print tape 10.

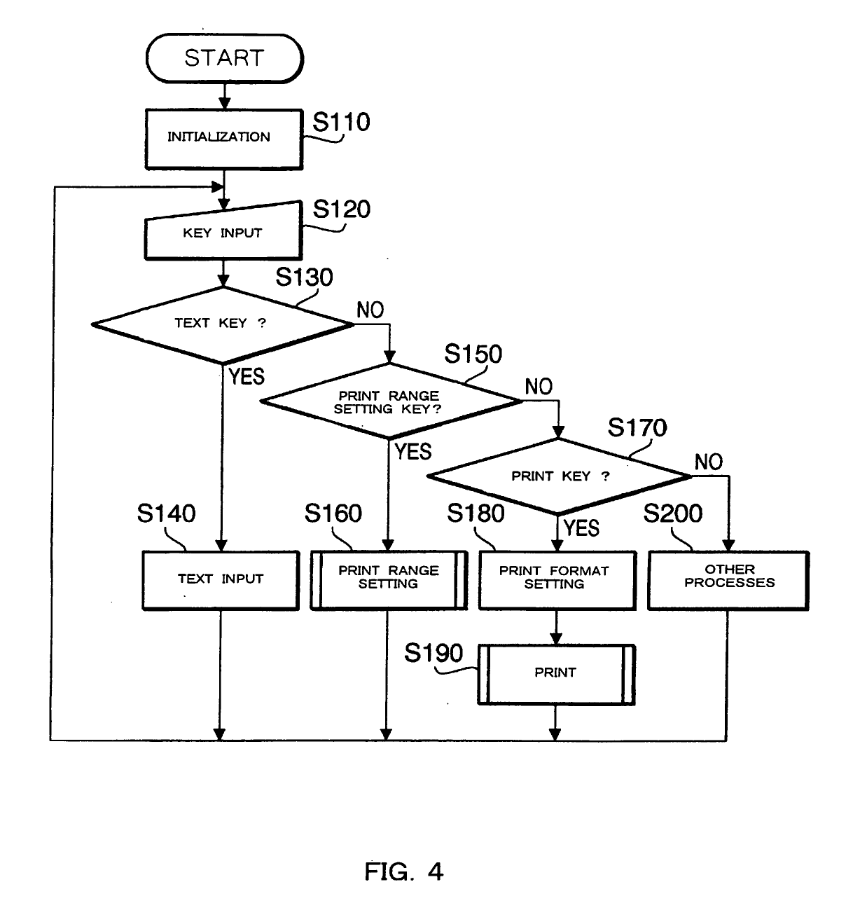

The control unit 6 includes a CPU (Central Processing Unit) 61, a ROM (Read Only Memory) 62, a RAM (Random Access Memory) 63, an interface unit 66 and a data bus 65. The CPU 61 executes calculations according to various commands. The ROM 62 stores programs for letting the CPU 61 execute various processes shown in FIGS. 4 through 9 (programs for implementing functional modules shown in FIG. 3), graphic data such as font data of characters and pattern data of frames for decorating printed characters, and various data necessary for the execution of the programs. The RAM 63 includes temporary storage areas (work area (print range storage means), etc.) for storing data to be used by the CPU 61 executing the programs.

The interface unit 66 electrically connects the control unit 6 with devices as separate modules (the display 2, the keyboard 3 and the printing head 4) directly or indirectly. The data bus 65 is a group of data transmission lines for electrically connecting the CPU 61, the ROM 62, the RAM 63 and the interface unit 66 together. All the data transmission in the control unit 6 is performed through the data bus 65.

Next, the functions of the tape printer 1 will be described. As shown in FIG. 3, the CPU 61 includes a print range setting module (print range setting means) 611, a character size determination module (character size determination means) 612, a character image generation module (character image generation means) 613, a print control module (print control means) 614, a recommended width determination module (recommended width determination means) 615 and an informing module (informing means) 616.

The RAM 63 includes a character string storage module (character string storage means) 631. The character string storage module 631 stores character data of each character of the character string (as the object of printing) inputted by the user through the keyboard 3. The character data include text codes corresponding to font data stored in the ROM 62 and data determining character decoration, character size, etc.

The print range setting module 611 sets the print range (indicating an area in which the character string stored in the character string storage module 631 can be printed) according to specification by the user. Concretely, the print range setting module 611 sets an area specified by a label length (the length of the label to be created in the lengthwise direction of the print tape 10) and a label width (the width of the print tape) as the print range. The specification of the print range by the user may either be direct specification of the label length or specification of the external diameter of a cable-like member (around which a label such as the cable label 11 is wound to be stuck thereon). When the external diameter of the cable-like member is specified, the print range setting module 611 calculates the perimeter of the cable-like member from the specified diameter and sets the print range based on the calculated perimeter. When the user does not specify the print range, a preset default value may be used.

The character size determination module 612 adjusts the character size of the character string as the object of printing so that a print image generated by the character image generation module 613 will be accommodated in the print range set by the print range setting module 611.

The character image generation module 613 generates a print image of the character string (stored in the character string storage module 631 to be printed on the print tape 10) rotated counterclockwise from the lengthwise direction of the print tape by 90 degrees (i.e. a print image in which the characters are arranged in the width direction of the print tape). Incidentally, “to generate a print image” means spreading dot pattern data (corresponding to actual print status) in the work area of the RAM 63 based on the text data of the character string, the character size which has been set, the font shape, the presence/absence of line decoration such as the character decoration (boldface, oblique face, etc.) and frames.

The print control module 614 controls printing operation of the tape printer 1. In the creation of the cable label 11, the print control module 614 executes print control so that the print image generated by the character image generation module 613 will be printed at both ends of the set print range in the lengthwise direction of the print tape. Or the print control module 614 executes the print control so that the character string will be printed at both ends of the print range and further the same character string will be printed repetitively between the character strings (at both ends) at even intervals. The number of print images to be printed on the cable label 11 may either be directly specified by the user or calculated based on line spacing specified by the user, the height and the number of lines of the character string to be printed, and the print range which has been set.

In the creation of the cable label 11, if the external diameter of the cable has been inputted, the recommended width determination module 615 determines a recommended width of a print tape that is suitable for being stuck on the cable having the external diameter. For example, when the diameter of the cable is small, sticking a too wide cable label 11 on the cable causes too high flexural rigidity of the part wound with the cable label 11, hampering the handling and wiring of the cable. On the other hand, if a cable label 11 of a too small tape width is used, adhesive area of the cable label 11 becomes too small and the cable label tends to come off when the cable having a small external diameter bends. Specifically, the recommended width determination module 615 obtains the print tape width to be recommended by referring to a data table stored in the ROM 62 indicating the correspondence between cable external diameters and tape widths suitable for the cable label 11.

The informing module 616 executes display control to display the tape width recommended by the recommended width determination module 615 on the display 2.

Next, processes to be executed by the tape printer 1 of this embodiment will be described referring to FIGS. 4 through 9. The processes shown in FIGS. 4 through 9 are carried out under the control by the CPU 61.

FIG. 4 is a flowchart showing an overall process to be executed by the tape printer 1.

The process of FIG. 4 is started when the power of the tape printer 1 is turned on. First, in a step Silo (hereinafter abbreviated as “S110”, ditto for the following steps), the whole tape printer 1 is initialized. Specifically, the operation check and initialization of the CPU 61, the RAM 63 and the interface 66, the operation check of the display 2 and the printing head 4 connected to the interface 66, and the initialization of hardware are carried out. If no abnormality is found in the operation check of each component, the data to be stored in the RAM 63 and each functional module are initialized. After the operation check and initialization is finished, the CPU 61 displays an operation screen on the display 2. Thereafter, the process advances to S120.

In S120, the CPU 61 waits for a key input by the user. The user can input a character string and operate the tape printer 1 by making key inputs through the keyboard 3 while seeing a screen displayed on the display 2. The tape printer 1 after the initialization stays on standby in a state allowing the input of character string, in which the user can input the character string (the object of printing) by pressing the text keys arranged on the keyboard 3. Even in the input standby state, the user can call various functions by pressing function keys such as a print key. When a key is pressed by the user, the CPU 61 stores a key code corresponding to the pressed key in the work area of the RAM 63. Next, the process advances to S130.

In S130, whether the key pressed in S120 is a text key is judged based on the key code corresponding to the key. If the key is a text key (S130: YES), the process advances to S140 and a text input process is executed. The text input process means a process for obtaining a text code corresponding to the key code stored in S120 and storing the text code in the character string storage module 631 as the character data. After the text input process (S140) is finished, the process returns to S120 and the CPU 61 waits for a key input by the user.

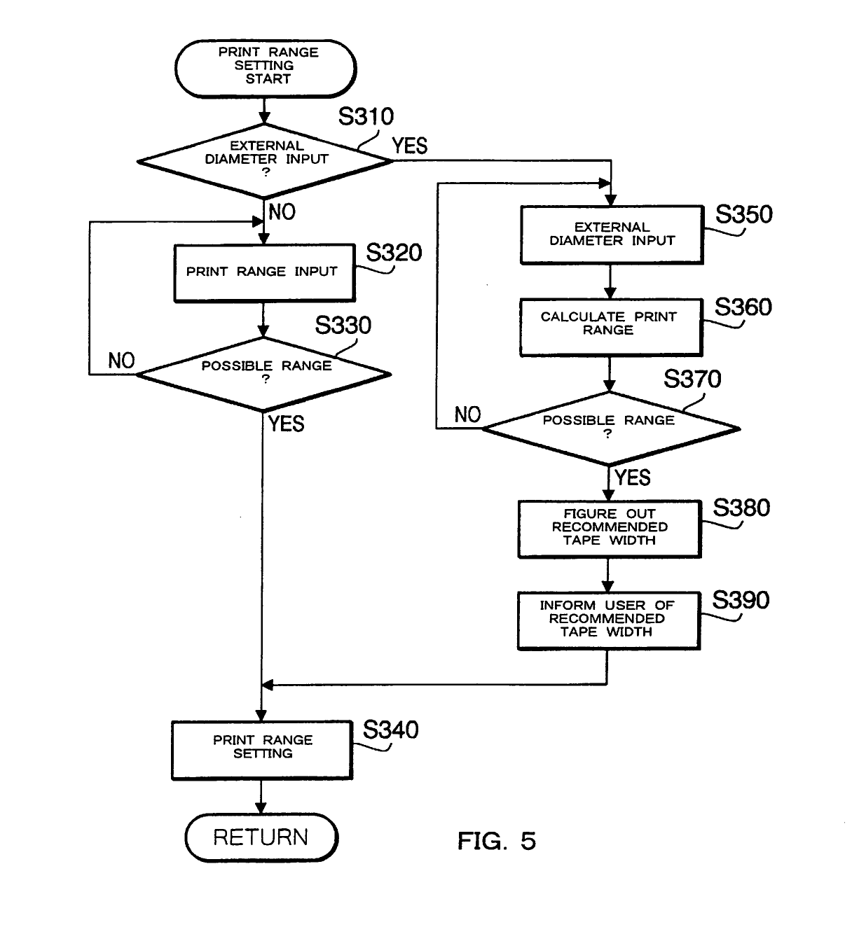

If the key pressed in S120 is not a text key in S130 (S130: NO), the process advances to S150 and the CPU 61 judges whether the key pressed in S120 is the print range setting key. If the key is the print range setting key (S150: YES), the process advances to S160 and the CPU 61 executes a print range setting (FIG. 5). The print range setting (FIG. 5) is a process to be executed by the print range setting module 611 of the CPU 61, in which the print range of the character string (as the object of printing) stored in the character string storage module 631 is set. After the print range setting is finished, the process returns to S120 and the CPU 61 waits for a key input by the user.

If the key pressed in S120 is not the print range setting key in S150 (S150: NO), the process advances to S170 and the CPU 61 judges whether the key is the print key. If the key is the print key (S170: YES), the process advances to S180 and the CPU 61 executes a print format setting.

Here, the contents of the print format setting will be explained. The print format setting includes settings of the format of the character string in the printing, style or appearance as printed matter, etc.

The styles as printed matter set by the print format setting include the normal printing, the rotated printing and the cable label printing. The user selects and sets a desired style out of the above styles. When the user has selected the cable label printing, a setting is made further regarding the number of lines of character strings to be printed on the cable label 11 or the distance between character strings. When the user hopes to create the cable label 11 shown in FIG. 2(a), the number of lines is set to “2”.

When the character string to be printed extends for two or more lines in the cable label printing, a setting is made further regarding whether to treat each line of the character string as one character string. For example, when the character string stored in the character string storage module 631 is one extending for two lines including “ABCD”, “1234” and a line feed between them, if the setting is made to treat the whole character string of two lines as one character string, the printing is carried out as in the cable label 11 shown in FIG. 2(c). On the other hand, if the setting is made to treat each line of the character string as one character string, the cable label 11 shown in FIG. 2(d) is created.

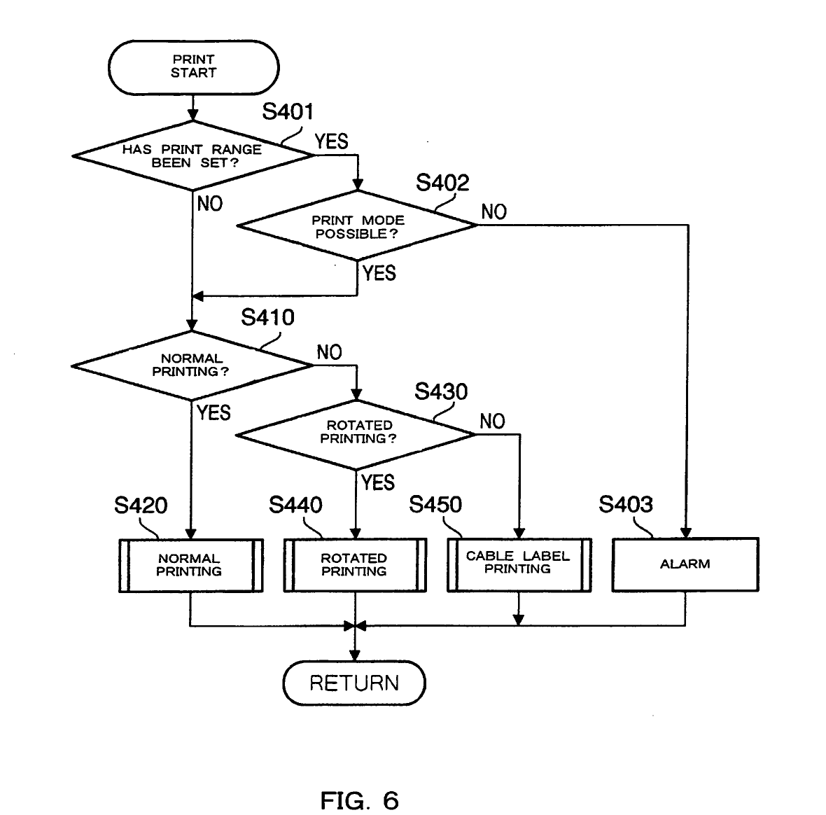

After the print format setting (S180) is finished, the process advances to S190 and a print process (FIG. 6) is executed. After the print process (S190) is finished, the process returns to S120 and the CPU 61 waits for a key input by the user.

If the key pressed in S120 is not the print key in S170 (S170: NO), the process advances to S200 and the CPU 61 executes other processes. The “other processes” include processes corresponding to functions keys other than the print key, processes corresponding to the cursor keys, etc. After the “other processes” (S200) are finished, the process returns to S120 and the CPU 61 waits for a key input by the user.

The procedure of the print range setting to be executed in S160 of FIG. 4 will be explained below referring to FIG. 5. FIG. 5 is a flowchart showing the procedure of the print range setting. As mentioned above, when the object of application of the label is a cable-like member, the print range can be set either by inputting the label length or by inputting the external diameter of the cable-like member. First, in S310, whether the way of print range setting is inputting the external diameter is judged. If the print range setting is not by the external diameter input (S310: NO), the process advances to S320 and the print range is inputted by the user in terms of the label length.

In the next S330, whether the inputted print range is a proper range is judged. Whether the print range is proper is judged based on whether the value of the inputted print range is between minimum and maximum values of the print range. The minimum and maximum values of the print range may be preset to the tape printer 1 as specifications. In cases where the tape printer 1 is provided with a mechanism for detecting the type of the print tape 10, the minimum and maximum values of the print range may be automatically determined by the tape printer 1 according to the detected tape type. If the inputted print range is improper (S330: NO), the process returns to S320 and an input of print range by the user is waited for. If the print range is proper (S330: YES), the process advances to S340 and the inputted print range is spread in the work area of the RAM 63. Thereafter, the print range setting of FIG. 5 is ended and the process returns to S120 of FIG. 4.

If the way of print range setting is inputting the external diameter in S310 (S310: YES), the process advances to S350 and the external diameter of the cable-like member on which the cable label 11 should be applied is inputted by the user.

In the next S360, the print range is calculated based on the inputted external diameter. The print range is obtained in this step as the sum of a perimeter calculated from the external diameter of the cable-like member inputted in S350 and the length of an overlapping part (a rear end part of the label overlapping with a front end part of the label) of the label wound around the cable-like member. In short, the calculated print range corresponds to the label length. Subsequently, the process advances to S370 and whether the print range is proper is judged. The judgment on the propriety of print range in S370 is made similarly to the judgment in S330. If the print range is improper (S370: NO), the process returns to S350 and the CPU 61 waits for an input of the external diameter by the user. If the print range is proper (S370: YES), the process advances to S380.

In step S380, a print tape width optimum for the application on the cable-like member having the inputted external diameter is figured out by the recommended width determination module 615 of the CPU 61. In the next S390, the tape width figured out by the recommended width determination module 615 is displayed on the display 2 by the informing module 616 as a recommended tape width, that is, the user is informed of the recommended tape width. Subsequently, the process advances to S340 and the print range is spread in the work area of the RAM 63. Thereafter, the process returns to S120 of FIG. 4.

Next, the procedure of the print process to be executed in S190 of FIG. 4 will be explained below referring to FIG. 6. FIG. 6 is a flowchart showing the procedure of the print process. First, in S401, whether the print range has already been set by the user in the print range setting (S160 in FIG. 4) is judged. If the print range has not been set yet (S401:NO), the process advances to S410. If the print range has already been set (S401: YES), the process advances to S402 and the CPU 61 further judges whether the printing is possible within the set print range. If the printing is possible (S402: YES), the process advances to S410. If the printing is impossible (S402: NO), the CPU 61 displays an alarm message on the display 2 (S403). Thereafter, the print process (FIG. 6) is ended and the process returns to S120 of FIG. 4.

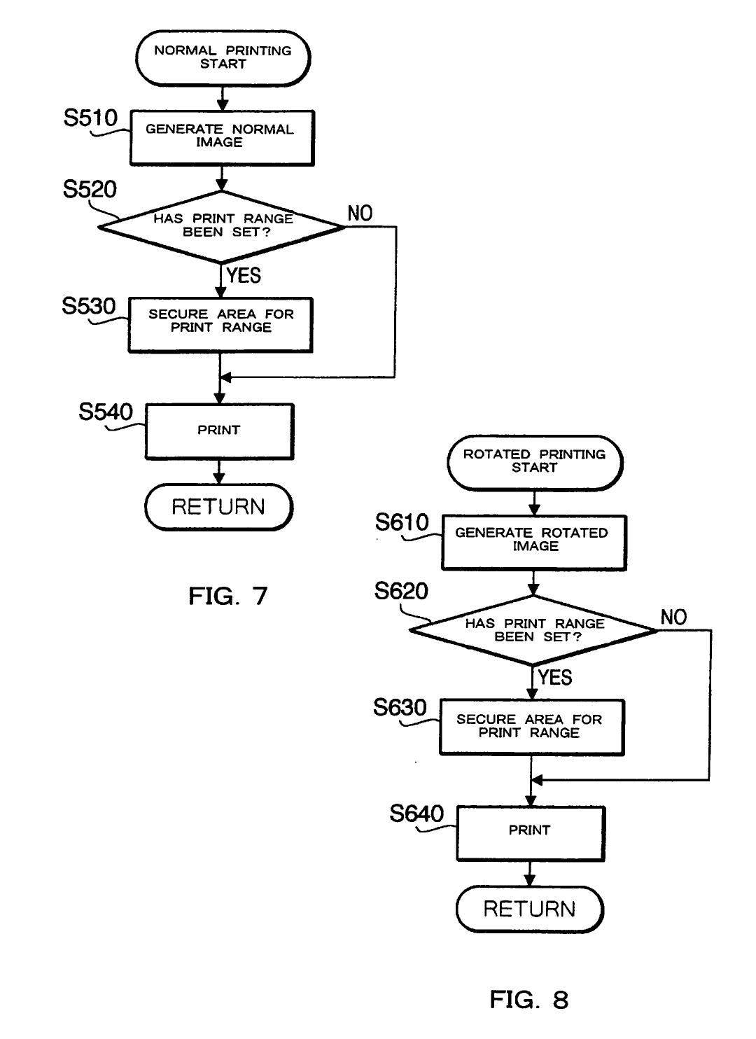

In S410, whether the print style set in the print format setting (S180 of FIG. 4) is the normal printing is judged. If the set print style is the normal printing (S410: YES), the process advances to S420 and a normal printing process (FIG. 7) is executed. When the normal printing process (FIG. 7) is finished, the print process of FIG. 6 is ended and the process returns to S120 of FIG. 4.

If the set print style is not the normal printing in S410 (S410: NO), the process advances to S430 and whether the set print style is the rotated printing is judged. If the set print style is the rotated printing (S430: YES), the process advances to S440 and a rotated printing process (FIG. 8) is executed. Thereafter, the print process of FIG. 6 is ended and the process returns to S120 of FIG. 4.

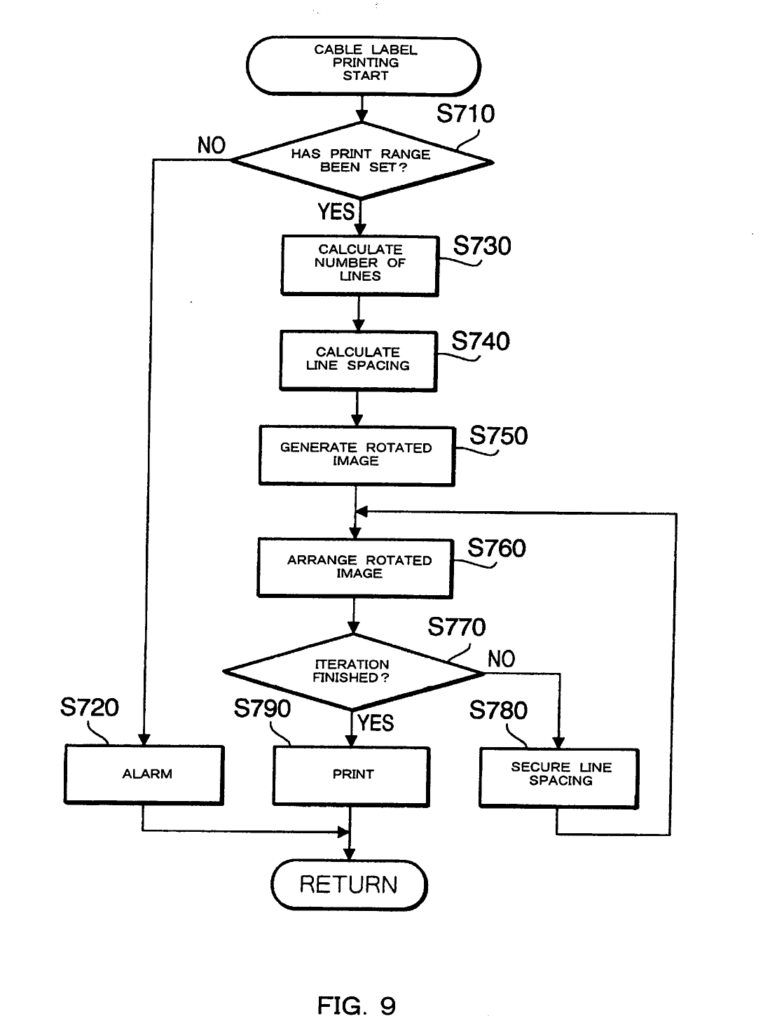

If the set print style is not the rotated printing in S430 (S430: NO), the process advances to S450 and a cable label printing process (FIG. 9) is executed. Thereafter, the print process of FIG. 6 is ended and the process returns to S120 of FIG. 4.

Next, the procedure of the normal printing to be executed in S420 of FIG. 6 will be explained below referring to FIG. 7. FIG. 7 is a flowchart showing the procedure of the normal printing. First, in S510, a print image is generated according to the settings made in the print format setting (S180 of FIG. 4). In this step, the character size of the character string is adjusted by the character size determination module 612 so that the generated print image will fit in the print range.

In the next S520, whether the print range has been set by the print range setting module 611 is judged. If the print range has been set (S520: YES), the process advances to S530 and the CPU 61 adds blank areas (in which nothing is printed) on both sides of the print image in the lengthwise direction of the print tape 10 so as to place the print image at the center of the print range. In the next S540, the printing is carried out.

If no print range has been set (S520: NO), the process advances to S540 and the generated print image is printed just as it is, by which the normal printing process of FIG. 7 is ended.

Next, the procedure of the rotated printing to be executed in S440 of FIG. 6 will be explained below referring to FIG. 8. FIG. 8 is a flowchart showing the procedure of the rotated printing. First, in S610, a print image of the character string (object of printing) rotated counterclockwise from the lengthwise direction of the print tape 10 by 90 degrees is generated by the character image generation module 613 so as to arrange the character string in the width direction of the print tape 10, according to the settings made in the print format setting (S180 of FIG. 4). In this step, the character size of the character string is adjusted by the character size determination module 612 so that the generated print image will fit in the print range.

In the next S620, whether the print range has been set by the print range setting module 611 is judged. If the print range has been set (S620: YES), the process advances to S630 and the CPU 61 adds blank areas (in which nothing is printed) on both sides of the print image in the lengthwise direction of the print tape 10 so as to place the print image at the center of the print range. In the next S640, the printing is carried out.

If no print range has been set (S620: NO), the process advances to S640 and the generated print image is printed just as it is, by which the rotated printing process of FIG. 8 is ended.

Next, the procedure of the cable label printing to be executed in S450 of FIG. 6 will be explained below referring to FIG. 9. FIG. 9 is a flowchart showing the procedure of the cable label printing. First, in S710, whether the print range has been set by the print range setting module 611 is judged. The cable label printing requires the print range to have been set since the label length is fixed. If no print range has been set (S710: NO), an alarm message (indicating that the print range is necessary) is displayed on the display 2 (S720) and the cable label printing process of FIG. 9 is ended.

If the print range has been set in S710 (S710: YES), the process advances to S730 and the number of lines of the character string to be printed on the cable label is calculated. The calculation of the number of lines is performed based on the settings made in the print format setting (S180 of FIG. 4). Specifically, in the case where the number of character strings to be printed on the cable label 11 has been set, when the inputted character string is within a line, the set number of character strings is regarded as the number of lines as the result of calculation of S730. Even when the inputted character string extends for two or more lines, if a setting has been made to treat the whole character string of two or more lines as one line, the set number of character strings is regarded as the number of lines as the result of calculation of S730. On the other hand, even in this case (where the inputted character string extends for two or more lines), if a setting has been made to treat each line of the character string of two or more lines as one line, the set number of character strings multiplied by the number of lines of the inputted character string is regarded as the number of lines as the result of calculation of S730.

In the case where the distance between character strings to be printed on the cable label 11 (line spacing) has been set, the number of lines is figured out so that the character string will be arranged at both ends of the cable label 11 in the lengthwise direction of the print tape and at even intervals between the character strings at both ends, based on the label length set by the print range setting module 611 as the print range, the distance between character strings (line spacing) and the height of the character string. Also in this case, there are two treatments when the inputted character string extends for two or more lines, as mentioned above. Incidentally, when all the conditions (the label length set by the print range setting module 611 as the print range, the distance between character strings and the height of the character string) have been set, there are cases where the request of arranging the character string at both ends of the print range in the lengthwise direction of the print tape and at even intervals between the character strings at both ends can not be met perfectly. In such cases, the print control module 614 copes with the situation by slightly changing the label length, the line spacing or the character string height, by shifting the positions of the character strings arranged at both ends, or by properly combining the methods according to priority. Such slight modification gives no feeling of visual strangeness to the user in most cases. After the calculation of the number of lines is finished, the process advances to S740.

In S740, the line spacing for each character string to be printed on the cable label is calculated. The calculation of the line spacing is performed based on the settings made in the print format setting (S180 of FIG. 4). Specifically, in the case where each line spacing in the printing on the cable label 11 has already been set, the set value is used as it is. In the case where the number of character strings to be printed on the cable label 11 has been set, the line spacing is figured out so that the character string will be arranged at both ends of the cable label 11 in the lengthwise direction of the print tape and at even intervals between the character strings at both ends, based on the label length set by the print range setting module 611 as the print range, the number of lines calculated in S730 and the height of the character string. When a fraction occurs in the calculation of the line spacing, adjustment is made by distributing the fraction to some of the spaces. The adjustment causes almost no change in visual effect even though the line spacing is not strictly even. After the calculation of the line spacing is finished, the process advances to S750.

In S750, a print image of the character string to be printed, rotated counterclockwise by 90 degrees to be arranged in the width direction of the print tape, is generated by the character image generation module 613 according to the settings made in the print format setting (S180 of FIG. 4). Incidentally, if the setting for treating each line of the character string to be printed (extending for two or more lines) as one character string has been made, print images are generated successively for each line of the character string. In this step, the character size of the character string is adjusted by the character size determination module 612 so that the generated print image will fit in the print range.

In the next S760, the print images generated by the print control module 614 in S750 are successively arranged in the lengthwise direction of the print tape starting from the edge of the print range. Thereafter, the process advances to S770 and whether the arrangement has been finished for the number of lines calculated in S730 is judged. If the arrangement has not been finished yet (S770: NO), the process advances to S780 and the line spacing calculated in S740 is secured and the process returns to S760 for arranging a print image. The last character string in this case (where the print images are arranged for the number of lines calculated in S730 while securing the line spacing calculated in S740) is placed at an edge of the print range opposite to the edge where the first print image has been placed. When the arrangement is finished (S770: YES), the process advances to S790 and the printing is carried out (S790). In the printing (S790), a cut line 12 parallel to the width direction of the print tape, indicating the edge of the cable label 11, is also printed. Thereafter, the cable label printing process of FIG. 9 is ended.

By executing the above procedures, cable labels 11 shown in FIGS. 2(a)-2(d) suitable for being stuck on cable-like members, a normal printing label shown in FIG. 2(e) in which the character string is arranged in the lengthwise direction of the print tape, and a rotated printing label shown in FIG. 2(f) in which the character string is arranged in the width direction of the print tape can be obtained.

In this embodiment, the label length suitable for the application of the cable label 11 can be set only by inputting the cable diameter of a cable on which the cable label will be stuck, by which the user is released from the trouble of calculating the label length of the cable label. Further, even when the character size set by the user can not accommodate the character string in the print range, the character size is automatically adjusted to fit the character string in the print range, by which the creation of cable labels 11 is facilitated.

While the above description has been given of a preferred embodiment in accordance with the present invention, the present invention is not to be restricted by the above particular illustrative embodiment. Various modifications, design changes, etc. can be made to the embodiment without departing from the scope and spirit of the present invention described in the appended claims. For example, while the rotation of the character string is restricted to the 90-degree counterclockwise rotation with respect to the print tape 10 in the above embodiment, it is possible to allow rotation of any desired angle.

While the cut line 12 indicating the edge of the cable label 11 is printed in the cable label printing in the above embodiment, it is also possible to provide an automatic cutter to the tape printer 1 to cut the cable label at its both ends.

While the spacing between character strings to be printed on the cable label 11 is controlled to be even by the print control module 614 in the above embodiment, the spacing between character strings does not necessarily have to be even, that is, the spacing between character strings may also be uneven within an extent avoiding a feeling of visual strangeness to the user.

While the size of the print image is adjusted by the adjustment of the character size by the character size determination module 612 in the above embodiment, the size adjustment of the print image may also be made by adjusting character spacing in the character string to be printed. Or the adjustment of the print image may also be performed by directly compressing the print image.

While the data stored in the character string storage module 631 (that is, the data as the object of printing) are text data in the above embodiment, the data as the object of printing are not restricted to text data. For example, the data as the object of printing may also be codes corresponding to image data stored separately from the character string storage module 631, or the image data themselves.

While the tape printer 1 in the above embodiment is a device of a stand-alone type having the control unit 6 incorporated in the tape printer 1, the present invention is not restricted to the stand-alone type. For example, part or all of the functions of the control unit 6 may also be implemented by a personal computer which is connected to the tape printer 1 via an interface.

The character size of the character image generated by the character image generation module 613 may also be determined by the character size determination module 612 based on at least one selected from the number of characters of the character string stored in the character string storage module 631, the number of lines of the character string stored in the character string storage module 631, the size of the print range, the external diameter of the cable-like member, and the width of the tape-like print medium, by which character strings can be printed on labels in appropriate sizes.

The procedure of each process described in the above embodiment can be implemented by a program which is executed by a computer. Such a program can be stored in record media of various types (flexible discs, CD-ROMs, etc.) in a format readable and executable by a computer.

It is to be appreciated that the above description of the embodiment has been given by way of illustration and the present invention is not to be restricted by the particular illustrative embodiment but to be understood based on the description of the appended claims.

1. A tape printing control device comprising:
a character string memory which stores a character string to be printed on a tape-like print medium;
a print range memory which stores a print range on the tape-like print medium in which the character string will be printed;
a character image generator which generates a character image in which the character string stored in the character string memory is arranged in a width direction of the tape-like print medium; and
a print controller which controls print position of each character image so that the character image generated by the character image generator will be printed at both ends of the print range stored in the print range memory in regard to a lengthwise direction of the tape-like print medium.

2. The tape printing control device according to claim 1, wherein the print controller controls the print position of each character image so that the character image generated by the character image generator will be printed at both ends of the print range stored in the print range memory in regard to the lengthwise direction of the tape-like print medium and between the ends so as to equalize distances between the character images.

3. The tape printing control device according to claim 1, further comprising a setting system that sets at least one of the number of the character strings to be arranged in the print range stored in the print range memory and spacing between the character strings,
wherein the print controller controls the print position so that the character image will be arranged in both end parts of the print range and between the end parts evenly based on at least one of the number of the character strings and the spacing between the character strings set by the setting system.

4. The tape printing control device according to claim 1, wherein when a character string extending for two or more lines has been stored in the character string memory, the character image generator generates the character image treating the character string of two or more lines as one image.

5. The tape printing control device according to claim 1, further comprising:
a first external diameter input system through which an external diameter of a cable-like member can be inputted; and
a print range setting system which sets the print range stored in the print range memory based on the external diameter inputted through the first external diameter input means.

6. The tape printing control device according to claim 5, wherein the print controller determines the distance between the character images based on the external diameter inputted through the first external diameter input system.

7. The tape printing control device according to claim 1, further comprising a character size determination system for determining character size of the character image generated by the character image generator based on at least one selected from the number of characters of the character string stored in the character string memory, the number of lines of the character string stored in the character string memory, size of the print range stored in the print range memory, an external diameter of a cable-like member, and a width of the tape-like print medium.

8. The tape printing control device according to claim 1, further comprising:
a second external diameter input system through which an external diameter of a cable-like member can be inputted; and
a recommended width determination system for determining a recommended width of the tape-like print medium to be wound around the cable-like member based on the external diameter inputted through the second external diameter input system; and
an informing system for informing a user of the recommended width determined by the recommended width determination system.

9. The tape printing control device according to claim 1, wherein the print controller executes print control so that cut marks as marks indicating cutting positions will be printed at both ends of the print range stored in the print range memory in regard to the lengthwise direction of the tape-like print medium.

10. A computer program product comprising computer-readable instructions that cause a computer to execute:
a character string storage step of storing a character string to be printed on a tape-like print medium;
a print range storage step of storing a print range on the tape-like print medium in which the character string will be printed;
a character image generation step of generating a character image in which the character string stored by the character string storage step is arranged in a width direction of the tape-like print medium; and
a print control step of controlling print position of each character image so that the character image generated by the character image generation step will be printed at both ends of the print range stored by the print range storage step in regard to a lengthwise direction of the tape-like print medium.

11. The computer program product according to claim 10, wherein the print control step controls the print position of each character image so that the character image generated by the character image generation step will be printed at both ends of the print range stored by the print range storage step in regard to the lengthwise direction of the tape-like print medium and between the ends so as to equalize distances between the character images.

12. The computer program product according to claim 10, further comprising computer-readable instructions that cause the computer to execute a setting step of setting at least one of the number of the character strings to be arranged in the print range stored by the print range storage step and spacing between the character strings,
wherein the print control step controls the print position so that the character image will be arranged in both end parts of the print range and between the end parts evenly based on at least one of the number of the character strings and the spacing between the character strings set by the setting step.

13. The computer program product according to claim 10, wherein when a character string extending for two or more lines has been stored by the character string storage step, the character image generation step generates the character image treating the character string of two or more lines as one image.

14. The program according to claim 10, further comprising computer-readable instructions that cause the computer to execute a print range setting step for setting the print range stored by the print range storage step based on an inputted external diameter of a cable-like member.

15. The computer program product according to claim 14, wherein the print control step determines the distance between the character images based on the inputted external diameter of the cable-like member.

16. The computer program product according to claim 10, further comprising computer-readable instructions that cause the computer to execute a character size determination step of determining character size of the character image generated by the character image generation step based on at least one selected from the number of characters of the character string stored by the character string storage step, the number of lines of the character string stored by the character string storage step, size of the print range stored by the print range storage step, an external diameter of a cable-like member, and a width of the tape-like print medium.

17. The computer program product according to claim 10, further comprising computer-readable instructions that cause the computer to execute:
a recommended width determination step of determining a recommended width of the tape-like print medium to be wound around a cable-like member based on an inputted external diameter of the cable-like member; and
an informing step of informing a user of the recommended width determined by the recommended width determination step.

18. The computer program product according to claim 10, wherein the print control step executes print control so that cut marks as marks indicating cutting positions will be printed at both ends of the print range stored by the print range storage step in regard to the lengthwise direction of the tape-like print medium.

19. The tape printing control device according to claim 2, further comprising:
first external diameter input means through which an external diameter of a cable-like member can be inputted; and
print range setting means for setting the print range stored in the print range storage means based on the external diameter inputted through the first external diameter input means.

20. The program according to claim 11, further causing the computer to execute a print range setting step for setting the print range stored by the print range storage step based on an inputted external diameter of a cable-like member.
